(19) United States
(12) Patent Application Publication
(10) Pub. No.: US 2012/0284173 A1
(43) Pub. Date: Nov. 8, 2012

(54) METHODS AND SYSTEMS FOR FINANCING A VEHICLE PURCHASE

(75) Inventors: Paul-Henri Rene Jean Monjanel, Burlington (CA); Matthew James Straley, Dearborn, MI (US); James Charles Horr, Farmington Hills, MI (US)

(73) Assignee: FORD MOTOR COMPANY, Dearborn, MI (US)

(21) Appl. No.: 13/102,611

(22) Filed: May 6, 2011

(51) Int. Cl. G06Q 40/00

(52) U.S. Cl. 705/38

(57) ABSTRACT

Various embodiments relate to methods and systems for financing an acquisition of a vehicle. In at least one embodiment, a financing request may be submitted to a vehicle financier to finance an acquisition of a vehicle according to one or more vehicle financing programs specifically designed for a vehicle consumer. One or more financing offerings by the vehicle financier may be received for financing the acquisition of the vehicle based on the financing programs. A response indicating whether at least one financing offering is accepted or rejected may be transmitted to the vehicle financier.

### TECHNICAL FIELD

Various embodiments relate to financing methods and systems. In some embodiments, the financing methods and systems may relate to financing a purchase of a vehicle.

### BACKGROUND

Since a vehicle is a financially heavy investment, most vehicle purchasers use some form of financing to purchase the vehicle. For example, financing may come in the form of a vehicle lease or a loan from a financing company. In recent times, many elements of a finance and insurance (F&I) process have begun to move upstream to a dealership showroom floor. For example, preliminary or final decisions on which finance source(s) will be used in a vehicle purchase may be made prior to the F&I process.

There are various examples that illustrate different ways of financing a vehicle transaction. For example, U.S. Pat. No. 6,587,841 to DeFrancesco et al. ('841 Patent) discloses a computer implemented automated credit application analysis and decision routing system. The credit application and routing system includes a central processor having and executing a program. The system includes data input capabilities for selectively receiving credit application data from respective applicants at remote locations, and routing capabilities for selectively forwarding the credit application data to remote funding sources and selectively forwarding funding decision data from the funding sources to the respective applicants. The computer program includes routines for receiving a credit application from at least one remote application input and display device, for selectively forwarding a received credit application to at least one funding source, for receiving a funding decision from the at least one funding source, and for forwarding a received funding decision to the at least one remote application input and display device. The system disclosed in the '841 Patent can also obtain credit report data from credit bureau, and analyze and summarize the credit report data. A computer readable storage medium has a substrate physically configured to represent the computer program which causes a computer to provide the credit application and routing system.

U.S. Publication No. 2010/0023447 to Mac Innis (“Mac Innis Publication”) discloses a computer implemented finance management routing system. The Mac Innis Publication relates to a finance management system relating to the auto industry that provides a gateway for vehicle purchase lead management tools to seamlessly integrate the auto sales process with the auto finance process. Further, the system enables sellers to initiate, process, and decision loan transactions with financial institutions. The system disclosed in the Mac Innis Publication includes, among other things, credit filters, auto population of documents, and a decision engine that retrieves or collects and combines or merges the borrower's credit file(s) with an applicant's information, processes the information or data to a specific vehicle and finance structure, matches the data against a lender's proprietary mix of loan programs, pricing, credit policies and/or custom scoring models to determine if a borrower has qualified for a loan, and makes a result presentation of a finance level of acceptability available to the auto dealer.

### SUMMARY

One aspect includes a computer-implemented method for financing an acquisition of a vehicle. The method may include submitting a financing request via a computer to a vehicle financier to finance an acquisition of a vehicle according to one or more vehicle financing programs specifically designed for a vehicle consumer. One or more offerings by the vehicle financier for financing the acquisition of the vehicle may be received at the computer based on the one or more financing programs that are specifically designed for the vehicle consumer. A response to the one or more financing offerings may be transmitted to the vehicle financier.

Another aspect may include a method for financing an acquisition of a vehicle in which one or more vehicle financing programs may be suggested for a vehicle consumer. One or more financing offerings based on the suggested vehicle financing programs may be transmitted for presentation to the vehicle consumer. The vehicle consumer may make a decision on the one or more financing offerings for financing the acquisition of the vehicle and, based on the decision, an acquisition of the vehicle may be financed according to the terms of the financing offering.

Another aspect may include a system comprising a user computer which may be configured to receive input defining information about a purchase of an item and suggested financing plans for financing the purchase of the item. The item, in some embodiments, may be a vehicle. The computer may be further configured to transmit the purchase information and the financing plans information to a financier for financing the purchase. The computer may be further configured to receive financing offerings from the financier based on the information. Further, the computer may be configured to receive a selection of a financing offering and transmit the selection to the financier for financing according to terms of the selected offering.

These and other aspects will be better understood in view of the attached drawings and the following detailed description.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further objectives and advantages thereof, may best be understood with reference to the following description, taken in connection with the accompanying drawings, in which:

FIG. 1 illustrates a relationship diagram representing the relationship and data flow between a vehicle purchaser, a dealership, and a financier during a vehicle financing transaction according to the various embodiments;

FIG. 2 illustrates an exemplary block topology of a system for conducting a vehicle financing transaction according to the various embodiments; and

FIGS. 3A, 3B and 3C show non-limiting examples of graphical displays for performing various operations associated with a vehicle financing transaction according to the various embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Additionally, the disclosure and arrangement of the figures is non-limiting. Accordingly, the disclosure and arrangement of the figures may be modified or re-arranged to best fit a particular implementation of the various embodiments of the invention.

The various embodiments of the present invention are described herein within the context of vehicle financing transactions. It should be understood, however, that this is provided by way of example only and that the various embodiments of the present invention may be used within other types of environments.

In a typical vehicle financing transaction, a financing company may offer a single financing rate to all perspective vehicle purchasers. Whether the perspective purchaser receives financing is based on the purchaser's credit score. In some cases, different rates may be offered based on the period of financing. For example, the purchaser may be offered different financing rates for 60 months and 72 months financing. Similarly, different lease rates may be available depending on the length of the lease. Nevertheless, in each case, the only “choice” the purchaser has available is to choose the period of financing. As such, if the purchaser is not eligible based on a credit score, the purchaser may be required to look elsewhere for financing.

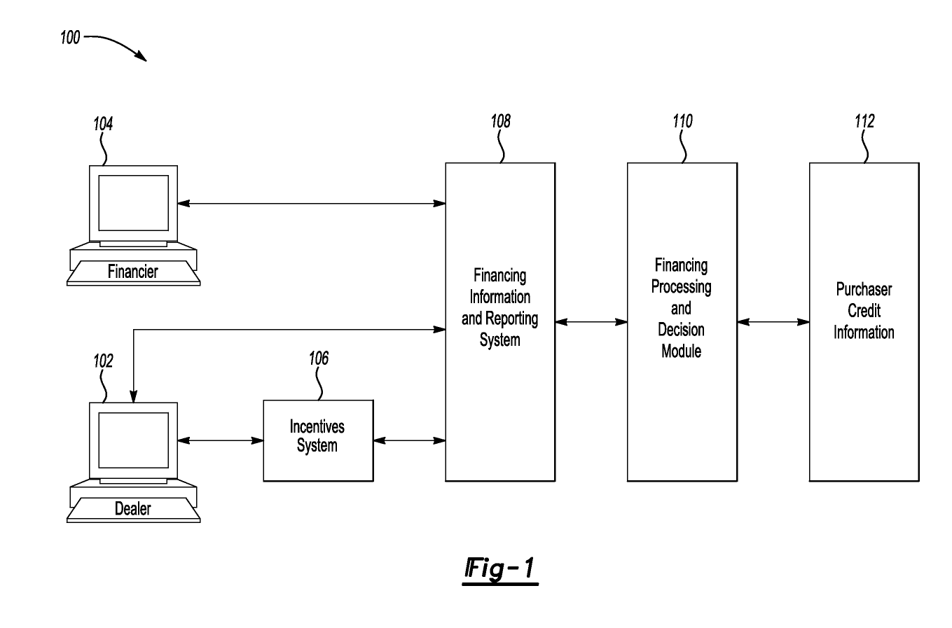

FIG. 1 is a block topology of a system that may be used in the various embodiments of the type of vehicle financing transaction described herein. A user 102 may facilitate the vehicle financing transaction using one or more computer terminals. As illustrated in the non-limiting embodiment of FIG. 1, the user 102 may be a dealer at the dealership. A dealership may include, but is not limited to, new and/or used car dealerships. Further, the dealership may or may not be affiliated with an OEM. For example, the dealership may be a car rental company. In other embodiments, the user 102 may be a purchaser of a vehicle.

The dealer 102 may interface with one or more computing systems and software programs during the vehicle financing transaction. In some embodiments, some or all of the computing system(s) and software program(s) may be affiliated with the financier such that the financier may host the computing system(s) and program(s).

An incentives system 106 may communicate incentives information from and/or to a vehicle financier during the vehicle financing process via the dealer terminal 102. The system 106 may be web-based system that the dealer 102 may securely access (e.g., a private URL and/or a public URL with restricted access via a login). The system 106 may include a graphical user interface and/or a text-based user interface. Further, the system 106 may be comprised of one or more server(s) for receiving and exchanging information between the dealer 102 and financier.

A financing information and reporting system 108 may exchange information from the dealer terminal 102, e.g., purchaser-related information and finance programs of interest to the purchaser, with the financing processing module 110 and/or purchaser credit information system 112. Additionally, the system 108 may obtain information about the financing (e.g., and without limitation, financing results) and report the information to the dealer 102. The system 108 may be comprised of one or more servers.

In some embodiments, the dealer 102 may interface directly with the financing information and reporting system 108 (e.g., bypassing the incentive system 106). In this embodiment, the vehicle financing transaction may be executed according to the various embodiments of the methods described herein, but the terms may not include any incentives. For completeness, details of the various embodiments are described herein with the use of the incentives system 106.

A financing processing and decision module 110 may process information obtained during a vehicle financing transaction and provide financing decisions to the dealer for presentation to the purchaser. Some non-limiting examples of operations performed by the module 110 may include, but are not limited to, receiving the financing programs in which the purchaser is interested, retrieving eligible financing programs for the purchaser (e.g., from a database of all possible financing programs offered by the financier), storing the financing programs selected by the dealer (on behalf of the purchaser), generating financing decisions, and submitting a credit application and credit offering to the purchaser credit information system 112. With respect to the eligible financing programs, the module 110 may, in some embodiments, generate the eligible financing programs using a programmed algorithm. The algorithm may generate the decision(s) based on information provided by the purchaser (in some embodiments, via the dealer 102) and information provided by the financier such as financing qualifying criteria. Other operations of the module 110 will be described below.

The system 108 may be comprised of one or more servers. In some embodiments, the financing processing module 110 may be a software application installed and executing on a server of the financing information and reporting system 108. In alternative embodiments, the module 110 may be a separate computing system comprising its own server(s) and software.

A purchaser credit information system 112 may receive and store credit information for the purchaser. The system 112 may receive credit application information which may be included in a credit profile for the purchaser. Further, when a decision on the credit offering is established, the system 112 may store the credit offering (e.g., the credit approval) received from system 110. The system 112 may be comprised of one or more servers.

Additionally illustrated in FIG. 1 is a financier terminal 104. The financier, via terminal 104, may connect to one or more systems for obtaining information about a vehicle financing. The financier may connect to the system(s) via a network connection, e.g., using an Intranet connection. In some embodiments, the financier 104 may make a decision on a purchaser selected financing programs from the financier terminal 104 and transmit the decision to the system 110. Further, the financier may also connect to the one or more systems for system management and maintenance purposes.

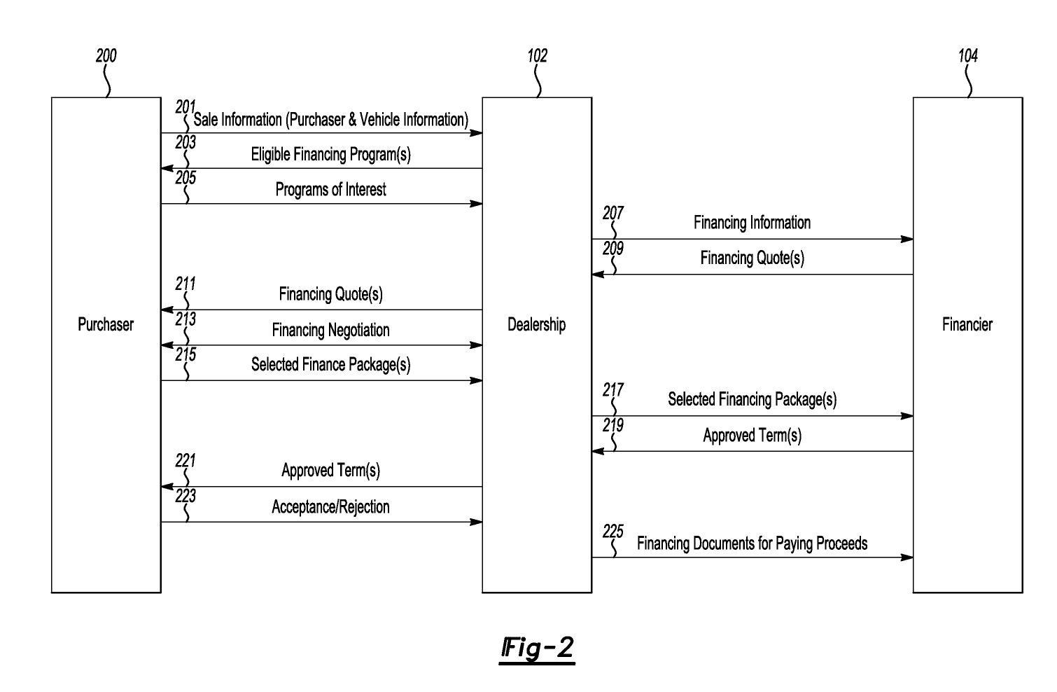

FIG. 2 is a diagram illustrating the relationship and flow of data between the various parties of the vehicle purchase financing process. In the non-limiting example illustrated in FIG. 2, the parties may be a vehicle purchaser 200, a vehicle dealership 102, and a vehicle financier 104. The vehicle financier 104 may be affiliated with an OEM (e.g., FORD MOTOR CREDIT COMPANY, LLC) or an independent financier (e.g., a bank, credit union, and the like). Therefore, in some embodiments, the transaction may be a three party transaction. Of course, other variants of a multi-party transaction may also be possible.

Certainly, in some environments, a direct relationship may exist between the purchaser 200 and the financier 104 for at least some of the operations described with respect to FIG. 2. Therefore, in some embodiments, the transaction may be a two party transaction. Additionally or alternatively, multiple intermediaries may exist between the purchaser 200 and the financier 104. For brevity, the relationship shown in FIG. 2 will be described herein.

The purchaser 200 may be an individual visiting the dealership 102 in order to purchase a vehicle. The purchaser may interface with a dealer at the dealership 102 who may be using a computing system or a network of computing systems for interfacing with the financier 104. The financier 104 may be a computing system or a network of computing systems. As described above, in some embodiments, the financier system 104 may include a human operator affiliated with the financier 104. Further details of the system topology are described above.

As is typical with the vehicle purchasing process, a purchaser 200 may search for and identify a vehicle of interest. During this process, such as while browsing for a vehicle or after identifying a vehicle, a dealer may gather information about the sale 101. The sale information 201 may include purchaser information and/or vehicle information. Purchaser information may include, but is not limited to, purchaser identification information such as, and without limitation, name, address, zip code, phone number, email address, and the like, and purchaser type (e.g., fleet customer or retail customer). Vehicle information may include, but is not limited to, vehicle identification information such as, and without limitation, VIN and vehicle line information. In some instances, the sale information may also include information about the sale such as the type of financing (e.g., a lease or a finance purchase), the term of financing, and the date of sale.

The sales information, once entered by a dealer at the dealership 102 may be used to obtain the financing programs for which the purchaser is eligible 203. An eligible program may be considered as a baseline program from which a financing program may be designed or configured for a purchaser. In some embodiments, the eligible programs may additionally or alternatively be programs for incentivizing a vehicle purchase. In further embodiments, an eligible program may additionally or alternatively be program(s) suggested to the purchaser based on the sales information. All eligible financing programs may be defined by the financier 104. In some embodiments, the available financing programs may be stored and/or generated by the one or more financier systems (e.g., at system 110).

The programs may be public programs and/or private programs. Public programs may be programs offered to the general public. In some embodiments, these programs may be based on purchaser residency. Private programs may be programs offered to promote renewal and loyalty to purchasers who already own a vehicle manufactured by the OEM (e.g., promote repeat purchasing by the purchaser). These available financing programs offered by the financier or the criteria for determining eligibility may be periodically (e.g., daily, weekly, monthly, or combinations thereof) modified and/or updated by the financier.

Further, in some embodiments, each financing program may include cash and incentives associated with the program. These programs may be defined by the financier and/or by the dealership.

From these available financing programs, the programs for which the purchaser is eligible may be identified and transmitted to the dealer 102 and displayed at the dealer terminal. The programs for which the purchaser is eligible may be provided without the use of a credit score for the purchaser. However, the purchaser may complete a credit application at any time during the vehicle purchasing process (e.g., before or after the financing process).

In some embodiments, the purchaser may be associated with a unique purchaser or customer number which may be used by the system 100 to identify the purchaser. In some embodiments, this purchaser number may be associated with multiple deals and multiple VINs.

The purchaser, presented with the eligible finance programs, may select the finance program(s) of interest 205. The selected program(s) of interest may represent the type(s) of finance products the purchaser seeks to use to finance the vehicle purchase. For example, and without limitation, the selected program(s) may include retail financing using subvented rates, retail financing using standard rates, and/or lease financing using standard rates. Of course, the terminology and types of financing programs may vary according to the specific implementation of the invention. Also, each program may include cash and incentive associated with each type of finance product. In some embodiments, the dealer 102 may present the purchaser 200 with compatible programs based on the select programs of interest.

The dealer 102 may submit the financing information 207 for processing by the financier. As used herein, financing information may include, but is not limited to, one or more of purchaser information, the vehicle information, and the one or more programs of interest. Other information that may be used to for processing by the financier (as described below) may also comprise financing information without departing from the scope of the invention. Some or all of this financing information may be used to pre-populate a credit application for the purchaser 200. This financing information 207 may be used as part of making a decision on the purchaser's financing.

In some embodiments, as part of the decision process, the dealer 102 may connect to (or be directed to) system 108 upon submitting the information 207. Here, further information (e.g., in addition to the information prepopulated from the incentives system 106 and based on the financing information) about the purchaser 200 may be collected. In some cases, this further information may be collected for the credit application.

Further, each program of interest selected by the purchaser may be further defined to include information for generating financing quote(s). These additional terms defined/selected by the purchaser may include, but are not limited to, balance, term(s), mileage bands (for lease financing), additionally added equipment dealer cost and MSRP. In some embodiments, the number of combinations of finance product types, incentive bundles, terms, and balances may be limited. For example, and without limitation, the purchaser (via the dealer 102) may select 6 possible combinations.

The dealer 102 may additionally input other incentives provided to the purchaser 200. This may include, but is not limited to, incentives privately offered by the dealer.

Once submitted, based on the information gathered from the purchaser 200, one or more quotes may be provided by the financier 209 according to the financing terms chosen by the purchaser 200. The quote(s) may represent the financing terms at which the financier is offering the vehicle financing to the purchaser. The quote(s) may be based on the credit score of the purchaser along with other information about the purchaser and the sale (as described above). The credit score may be based on information pulled from one or more credit bureaus. Accordingly, different purchasers may be offered different financing quotes. In some cases, each quote may be associated with a deal number. There may be multiple deals associated with a purchaser number.

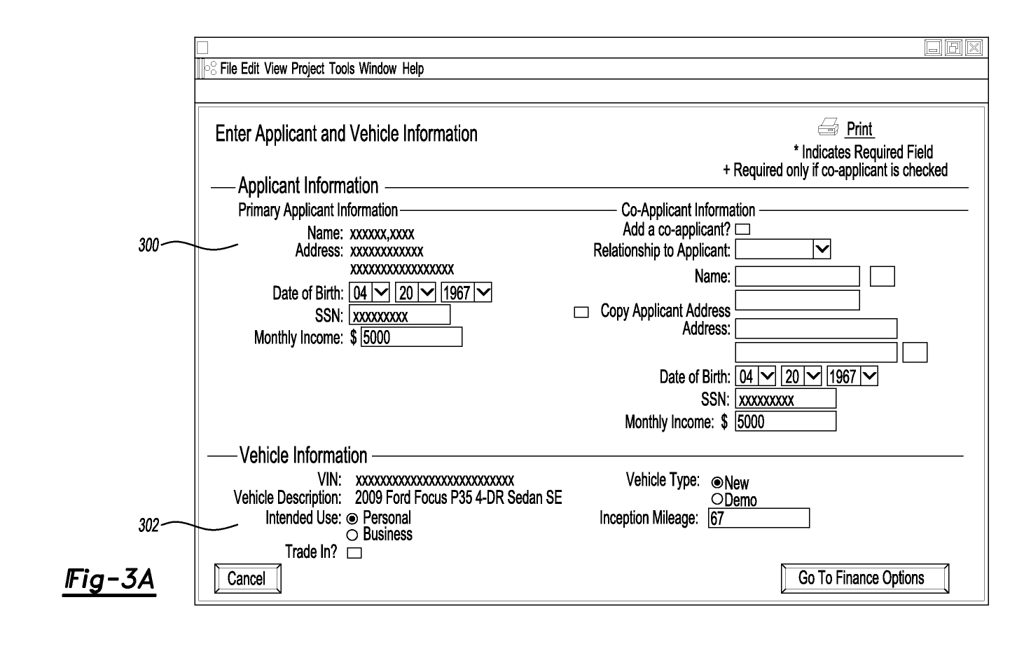

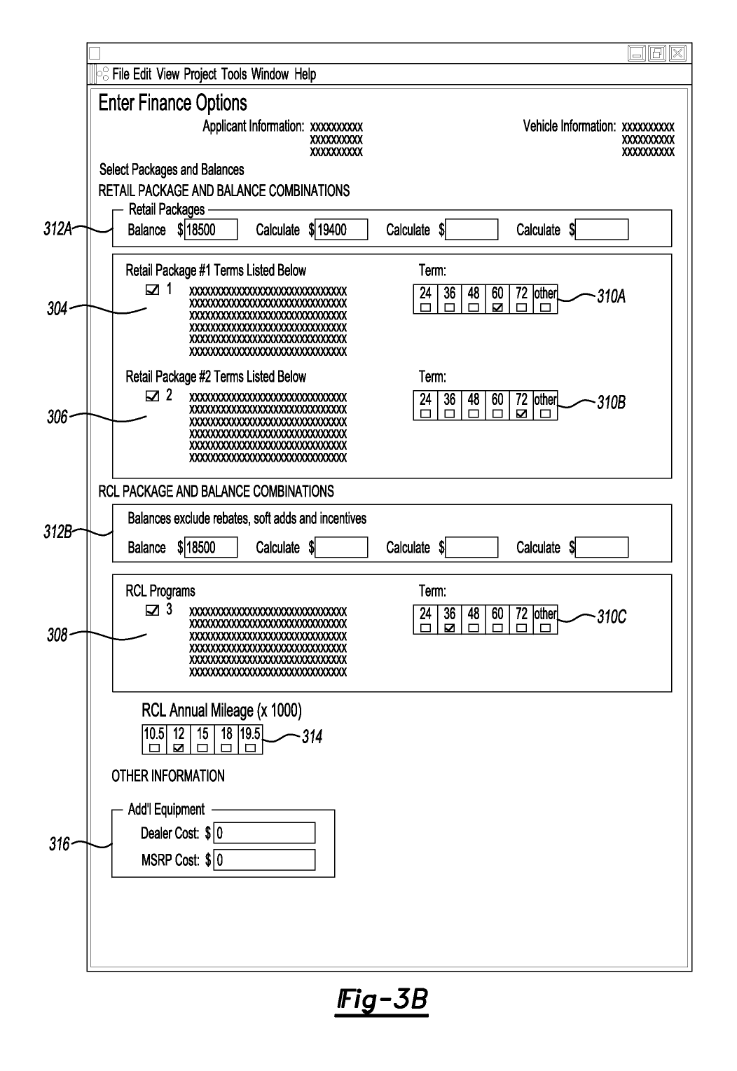

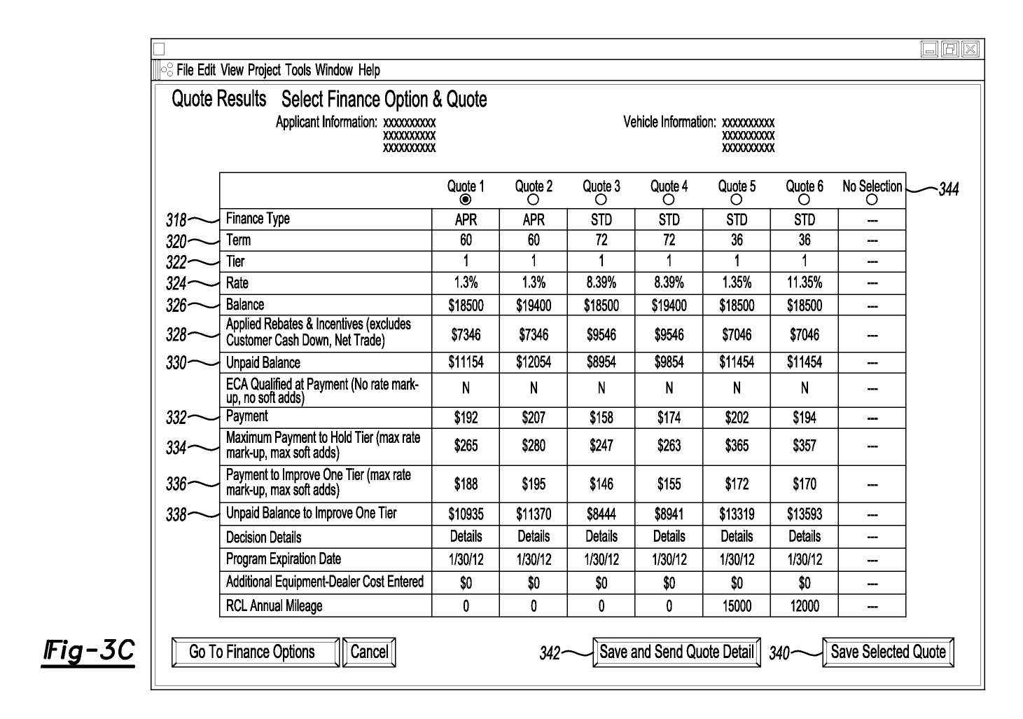

Each quote may include multiple financing packages. Based on a single or limited set of financing information 207 (as described above), multiple packages with varying financing terms can be presented for purchaser selection. In some cases, the multiple financing packages may be used to compare the different offerings from the financier 104. Accordingly, the purchaser 200 can choose which financing package may best suit them according to their needs and means. A non-limiting example of a display that may be shown at the dealer terminal 102 including the quote from the financier is shown in FIG. 3C. Further details of this display will be described below.

The financing quote(s) offered by the financier may be presented to the purchaser 211 via system 106. Based on the quote(s) offered by the financier, the purchaser and the dealership 102 may negotiate and discuss 213 the purchaser's choices among the one or more offered options. Consequently, the purchaser may choose, from the multiple packages, which financing program(s) the purchaser seeks to use to finance the vehicle purchase. The purchaser 200 may select one or more financing packages offered by the financier 215. From the dealer system 102, the selected financing package(s) may be transmitted 217 to the financier 104 so that a financing decision may be made on the selected financing package(s). The financier 104 may qualify the purchaser 200 for one finance program.

Additionally or alternatively, the purchaser 200 may choose to review the offers later. In this case, the quote(s) for the purchaser may be saved and reviewed upon revisit to the dealership. In some embodiments, the purchaser 200 may even review the offers at another dealership if desired. Typically, the dealerships may be affiliated, e.g., through a franchise. As such, if a purchaser visits multiple dealerships, the information may be accessible to another dealer.

The financier 104 may review the select package(s) in order to make a decision on whether to finally approve the package(s) and/or which package(s) to approve. Once approved, the approved term(s) (and, if multiple packages selected, which package) may be transmitted 219 to the dealership 102 for presentation 221 to the purchaser 200. For example, and without limitation, the approved terms may include sale type, the term, the tier, and the incentive bundle. In some embodiments, a decision on the financing package(s) may be made electronically (e.g., via Electronic Credit Approval). In the case where the package(s) are pre-approved, the financier 104 may confirm the approval based on the approval information and transmit 219 the approved term(s) to the dealership for presentation 221 to the purchaser 200. Additionally, the purchaser's credit application information may be stored in the purchaser credit information system 112.

Once presented with the financing offering from the financier, the purchaser 200 may accept or reject the financier's offering 223. If accepted, the financing documentation for paying the financing proceeds may be completed (based on the agreed terms) 225. The financier 104 may then pay the proceeds for the financing. Further, the purchaser 200 may be notified (via the system 106) of the purchased contract details.

In some embodiments, there may be a time limit (e.g., based on a number of days) for responding to the financier's offers. During this time period, the purchaser 200 may either explicitly accept or reject the financier's offers. The purchaser's rejection of the offer(s) may alternatively be identified if no response is received within the response time period.

Any information provided during the financing process may be modified. For example, the information used in generating the financing quote may be modified. By way of example and not limitation, the financing information may be modified. As an example, the purchaser 200 may elect to purchase a different vehicle because the purchaser cannot afford the payments based on the initial quote or decides to upgrade the vehicle. As such, the financing information may be change with respect to the vehicle information. In this case, all other information may be saved in order to avoid re-entry of unmodified information. One or more new quotes may be presented based on the modified information.

As another non-limiting example, the incentive bundles may be modified. The dealer 102 may do so in order to, for example, further optimize the financing (e.g., maximizing dealer profit). The dealer may navigate to a screen to modify this information.

FIGS. 3A, 3B, and 3C illustrates the display at system 106 shown during the vehicle financing process. FIG. 3A illustrates a display through which purchaser information 300 and vehicle information 302 may be entered. In some embodiments, the information in FIG. 3A may be populated based on information previously entered during the vehicle financing session (e.g., the purchaser and vehicle information from the incentives system 106 when determining the eligible programs for the purchaser).

FIG. 3B illustrates an interface for inputting information about the finance programs of interest for the purchaser 200. As with FIG. 3A, some information may be populated based on information previously entered during the vehicle financing session. As a non-limiting example, the information may be based on the flow of data in the purchaser-dealer relationship (e.g., received via incentive system 106) such as the financing programs for which purchaser is eligible 304, 306, and 308. As illustrated in FIG. 3B, information may be entered and/or populated about the purchaser's programs-of-interest. For example, and without limitation, the terms 310a, 310b, and 310c for each financing program may be entered and/or populated. Additionally, the balance 312a, 312b for each financing program may be entered and/or populated. The balance may include the amount that is being financed. Further, in cases where a vehicle is being leased, the mileage band 314 may be entered and/or populated. Additionally, any private offers from the dealer 316 may be entered and/or populated. In some embodiments, the number of combinations of finance product types, incentive bundles, terms, and balances may be limited. For example, and without limitation, there may be a maximum of 6 possible combinations which the purchaser may select.

FIG. 3C illustrates a results screen of the quote(s) offered by the financier based on the financing information. As show in FIG. 3C, the results may be displayed as a matrix. Of course, this is a non-limiting format and other display forms may be used. Further, while FIG. 3C shows six possible packages from which the purchaser may select, the number of packages may vary according to the specific implementation of the invention.

As illustrated in FIG. 3C, and described above, each quote may offer different financing terms. The finance product type 318 may refer to the type of financing offered to the purchaser 200. The term 320 may refer to the term of the financing. The tier 322 may refer to the credit tier for the purchaser 200. The credit tier may be determined based on the credit score of the purchaser. The interest rate 324 may refer to the interest rate offered to the purchaser 200 based on the financing information. As shown in FIG. 3C, there may be different interest rates offered to the purchaser 200. The balance 326 may be the balance or the amount financed before incentives. The term information 320 and the balance information 326 may be used to calculate the finance payment amount 332.

The applied rebates and incentives 328 may refer to the cash incentives included in the financing package. The unpaid balance 330 may refer to the amount financed after incentives. The maximum payment to hold tier 334 may refer to the amount paid by the purchaser to maintain the credit tier 322. This amount may differ for each package.

The purchaser 200 may also pay to increase the credit tier. The payment to improve a tier 336 field shows the amount that the purchaser 200 can pay to improve a tier. This amount may differ for each package. The unpaid balance to improve one tier 338 may refer to the amount of the unpaid balance if the purchaser 200 improved one tier. This amount may differ for each package.

The remaining exemplary financing terms illustrated in FIG. 3C are self-explanatory and, for purposes of brevity, will not be described

After reviewing the package(s) offered by the financier, the package(s) may be saved 340 for later retrieval. Alternatively or additionally, the selected package(s) may be saved and/or sent for a decision 342.

Of course, the purchaser may not select any package 344. If no package is selected 344, the financing process may be performed again (e.g., with a different vehicle). Alternatively, the vehicle purchasing process may be terminated.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer-implemented method for financing an acquisition of a vehicle, the computer-implemented method comprising:
submitting via a computer a financing request to a vehicle financier to finance an acquisition of a vehicle according to one or more vehicle financing programs specifically designed for a vehicle consumer;
receiving via the computer one or more financing offerings by the vehicle financier for financing the acquisition of the vehicle based on the one or more financing programs; and
transmitting a response to the vehicle financier for the one or more financing offerings.

2. The computer-implemented method of claim 1 further comprising receiving at the computer one or more baseline financing programs on which the one or more vehicle financing programs specifically designed for the vehicle consumer are based.

3. The computer-implemented method of claim 2 wherein the one or more baseline financing programs are determined by the vehicle financier.

4. The computer-implemented method of claim 2 wherein the baseline financing programs are based on at least one of information about the vehicle consumer and information about the vehicle.

5. The computer-implemented method of claim 1 wherein the one or more vehicle financing programs specifically designed for a vehicle consumer is not based on one or more credit scores of the vehicle consumer.

6. The computer-implemented method of claim 1 wherein the one or more financing offerings are based on one or more credit scores of the vehicle consumer.

7. The computer-implemented method of claim 1 further comprising selecting via the computer at least one financing offering from the vehicle financier.

8. The computer-implemented method of claim 7 wherein the response is an acceptance and includes the selected financing offering.

9. The computer-implemented method of claim 8 wherein the acquisition of the vehicle is financed according to terms of the selected financing offering.

10. The computer-implemented method of claim 1 wherein the response is an explicit or implicit rejection.

11. The computer-implemented method of claim 1 wherein the financing programs specifically designed for the vehicle consumer include vehicle acquisition incentives.

12. The computer-implemented method of claim 11 wherein the vehicle acquisition incentives are offered by the financier, the dealer, or both.

13. A method for financing an acquisition of a vehicle, the method comprising:
receiving on a computer one or more vehicle financing programs suggested for a vehicle consumer;
transmitting from the computer one or more financing offerings based on the suggested vehicle financing programs for presentation to the vehicle consumer;
receiving at the computer a decision from the vehicle consumer on the one or more financing offerings for financing the acquisition of the vehicle; and
based on the decision, financing the acquisition of the vehicle according to the terms of the financing offering.

14. The method of claim 13 wherein the one or more offerings to the vehicle consumer are at least partially different than the one or more offerings to a second vehicle consumer.

15. The method of claim 13 wherein the one or more vehicle financing programs suggested for the vehicle consumer are vehicle financing programs specifically designed for the vehicle consumer based on information about the vehicle consumer.

16. The method of claim 13 further comprising generating the one or more financing offerings based on the programs suggested for the vehicle consumer.

17. The method of claim 13 wherein the one or more financing offerings include at least two financing offerings, the method further comprising receiving a selection of a financing offering from the at least two financing offerings.

18. A system comprising:
a user computer configured to:
receive input defining information about a purchase of an item and suggested financing plans for financing the purchase;
transmit the information to a financier for financing the purchase;
receive financing offerings from the financier based on the information;
receive a selection of a financing offering; and
transmit the selection to the financier for financing according to terms of the selected offering.

19. The system of claim 18 wherein the item is a vehicle.

20. The system of claim 19 wherein the information about the purchase includes at least one of information about a consumer of the vehicle and information about the vehicle.

21. The system of claim 18 where the user computer is a dealer computer.

22. The system of claim 21 wherein the user computer is configured to store the financing offerings to memory, wherein the stored financing offerings may be accessed by multiple dealers.

23. The system of claim 18 wherein the suggested financing is one or more financing plans specifically designed for the vehicle consumer.
